(19) United States
(12) Patent Application Publication
(10) Pub. No.: US 2022/0016791 A1
(43) Pub. Date: Jan. 20, 2022

(54) FOLDING KNIFE WITH USER SELECTABLE KNIFE LOCKING MECHANISM

(71) Applicants: Zheng Huang, Chattanooga, TN (US); Chadwick Stirling Parker, Chattanooga, TN (US)

(72) Inventors: Zheng Huang, Chattanooga, TN (US); Chadwick Stirling Parker, Chattanooga, TN (US)

(21) Appl. No.: 17/305,077

(22) Filed: Jun. 30, 2021

Related U.S. Application Data
(60) Provisional application No. 62/705,835, filed on Jul. 17, 2020.

(51) Int. Cl. B26B 1/04

(52) U.S. Cl. CPC B26B 1/044

(57) ABSTRACT

A folding knife with user selectable knife locking mechanism is disclosed. The knife locking mechanism is selectable between a frictional lock mode and a frame lock mode. The frictional lock mode retains an extended blade of the folding knife with a frictional interference to limit the blade from inadvertent retraction. The frame lock mode prevents the extended blade from being retracted into the main body. A tension piece is resiliently moveable to selectively protrude within the interior cavity. A lock mode selector slide is movably carried on the tension piece and is operable to select between the friction lock mode and the frame lock mode.

### CROSS-REFERENCE TO RELATED APPLICATION

This application claims the benefit of priority of U.S. provisional application No. 62/705,835 filed Jul. 17, 2020, the contents of which are herein incorporated by reference.

### BACKGROUND OF THE INVENTION

The present invention relates to folding knives, and more particularly to apparatus and methods for locking a blade for folding knives.

Folding knifes have different ways of locking its blade in place. One such locking mechanism is a frame lock, which uses a portion of the main knife body frame to lock down the blade in an extended position when in use. When the blade is locked down, it's super secure and the blade is prevented from retracted into the main body while being used. Frame lock folding knifes can be perceived as being a more threatening weapon.

Another locking mechanism for a folding knife is the friction lock. The friction lock does not lock down the blade completely when in use. Instead, the friction lock provides some degree of friction against the extended knife blade, that restricts the movement of the blade to its retracted position within the main body. The friction lock prevents the blade from falling back into main body frame by accident or gravity. Friction lock folding knifes only work well with light duty cutting. Friction lock knives are perceived as being less threatening weapon.

While these different locking mechanisms exist, they are not incorporated into a single knife. A user will typically need to purchase a knife with one lock mechanism or the other. As such, they user must acquire a plurality of knives if they wish to have different a folding knife with a selected locking mechanism for a desired use.

As can be seen, there is a need for improved user selectable locking mechanism for a folding knife.

### SUMMARY OF THE INVENTION

In one aspect of the present invention, a knife that is configurable between a friction lock and a frame lock mode is disclosed. The knife includes a main body frame having a proximal end, a distal end, and an interior cavity. A blade has a root that is pivotally carried on a pivot at the distal end. The blade is moveable between a stowed position and an extended position. A switch mechanism is carried with the main body frame. The switch mechanism is operable between a friction lock mode, in which the blade is moveable between the stowed position and the extended position, and a frame lock mode, in which the blade locked in a fixed extended position relative the main body frame.

In some embodiments, the knife includes a tension piece resiliently moveable within the interior cavity. A lock mode selector slide is carried on the tension piece. The lock mode selector slide is operable to select between the friction lock mode and the frame lock mode.

In some embodiments, in the friction lock mode, a distal end of the lock mode selector slide is in frictional contact with a side surface of the root of the blade.

In other embodiments, in the frame lock mode, a distal end of the lock mode selector slide is positioned within the interior cavity and in abutment with a butt end of the root of the blade.

In some embodiments, a fastener is configured to retain the lock mode selector slide in one or more of the friction lock mode and the frame lock mode.

In some embodiments, a detent ball is carried by the lock mode selector slide. The detent ball is configured to retain the lock mode selector slide in one or more of the friction lock mode and the frame lock mode.

In yet other embodiments, a spring element is carried within the main body frame. A tang at a distal end of the spring element is configured for engagement with the root of the blade to apply a tension to the blade to retain the blade in each of the stowed position and the extended position.

In other aspects of the invention, a locking mechanism for a knife is disclosed. The knife having a main body frame, a proximal end, a distal end, and an interior cavity, the main body frame adapted to pivotally carry a blade moveable between a stowed position and an extended position. The locking mechanism includes a switch mechanism that is carried with the main body frame. The switch mechanism is operable between a friction lock mode, in which the blade is moveable between the stowed position and the extended position, and a frame lock mode, in which the blade locked in the extended position relative the main body frame:

In some embodiments, a tension piece is resiliently moveable to selectively protrude within the interior cavity. A lock mode selector slide is carried on the tension piece. The lock mode selector slide is operable to select between the friction lock mode and the frame lock mode. In the friction lock mode, a distal end of the lock mode selector slide is positionable in frictional contact with a side surface of a root of the blade. In the frame lock mode, a distal end of the lock mode selector slide is positioned within the interior cavity for abutment with a butt end of a root of the blade.

These and other features, aspects and advantages of the present invention will become better understood with reference to the following drawings, description and claims.

### BRIEF DESCRIPTION OF THE DRAWINGS

FIG. 1 is a top perspective view of the knife.

FIG. 2 is a bottom perspective view of the knife.

FIG. 3 is an exploded view of the knife.

FIG. 4 is a perspective view of the knife, shown in friction lock position.

FIG. 5 is a partial section view taken along line 5-5 from FIG. 4.

FIG. 6 is a perspective view of the knife, shown in frame lock position.

FIG. 7 is a partial section view taken along line 7-7 from FIG. 6.

FIG. 8 is a partial section view taken along line 8-8 from FIG. 2.

FIG. 9 is a partial section view taken along line 9-9 from FIG. 2.

### DETAILED DESCRIPTION

The following detailed description is of the best currently contemplated modes of carrying out exemplary embodiments of the invention. The description is not to be taken in a limiting sense but is made merely for the purpose of illustrating the general principles of the invention.

Broadly, embodiments of the present invention provides folding knife with user selectable knife locking mechanism. The folding knife allows a user to set the knife into “frame lock” mode or “friction” lock mode, which gives the user a choice of how they prefer to lock the blade in different cases of usage.

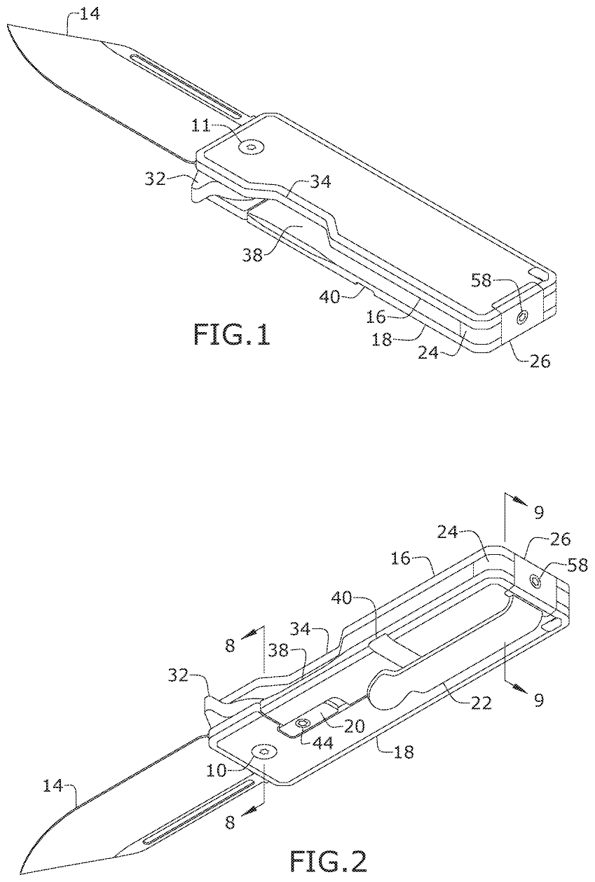

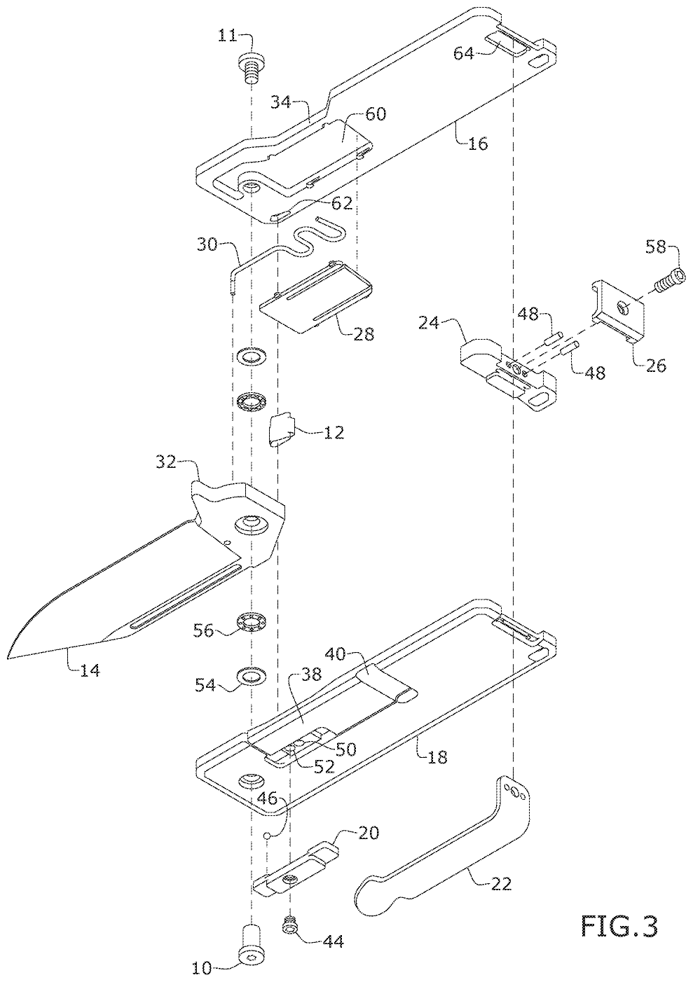

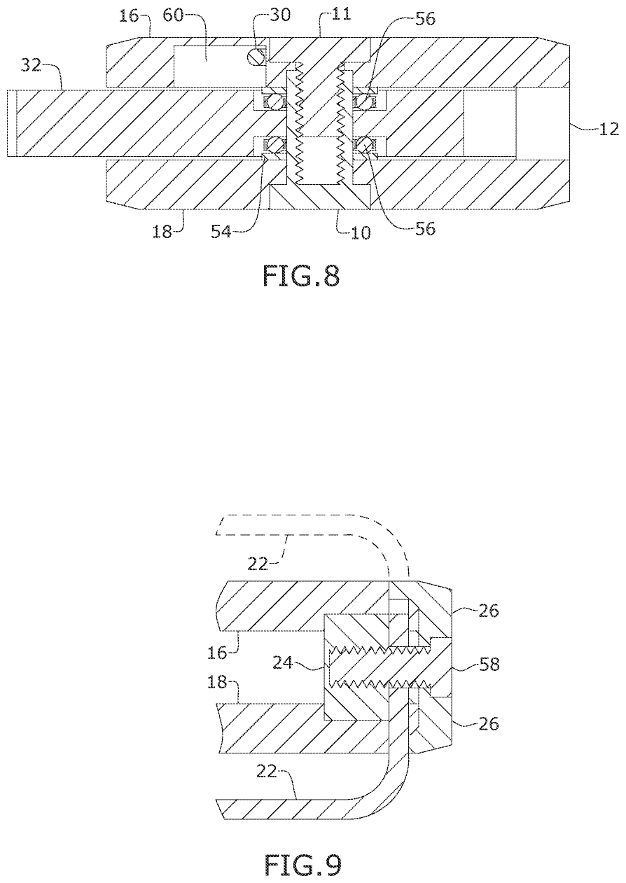

As seen in reference to the drawings of FIGS. 1-9, the folding knife includes a blade 14 that is pivotally attached to a main body frame about a pivot. The pivot may include a joinable pivot screw 10, 11, a washer 54, and a pivot bearing 56. In the non-limiting embodiment shown, the main body frame may include a first frame element 16 and a second frame element 18.

A spring element 30 may be carried within the main body frame. The spring element 30 has a tang at a distal end for engagement with a root 32 of the blade 14. In the embodiment shown, the spring element 30 may be received in a recess 60 formed in one of the first frame element 16 and the second frame element 18. A removable spring cover 28 may be provided for cleaning and servicing of the spring element 30. The spring element 30 applies a tension to the root 32 of the blade to retain the blade 14 in the stowed condition, when received within the main body frame, and the extended position, when pivoted about the pivot 10, 11. A blade stop 12 may be received within a socket 62 of the main body frame which engages with the root 32 of the blade 14 when moved to the extended position.

A switch mechanism is carried with the main body frame to selectively lock and unlock the blade 14. In a disengaged position, the blade 14 may be moved between a stowed position within the main body frame by pivotal movement of the blade 14 about the pivot. With the blade 14 deployed to an extended position, the switch mechanism is engageable with a root end 32 of the blade 14 to lock the blade 14 in the extended position.

The switch mechanism includes a tension piece 38 that is formed with or carried in a sidewall of one of the first frame element 16 or the second frame element 18. In the embodiment shown, the tension piece 38 is a resilient tab that may be depressed into an interior cavity of the main body frame when the blade 14 is in extended position. A lock mode selector slide 20 is carried on the tension piece and is moveable along a longitudinal length of the tension piece 38 between a blade engaging, frame lock position and a disengaged, friction lock position.

The lock mode selector slide 20 may be attached to the tension piece 38 via a fastener 44 that may be received in a first aperture 50 or a second aperture 52. The first aperture 50 and the second aperture 52 may alternatively be joined as a single aperture that is formed as a slot. A detent ball 46 may be provided to be received within the mode selector slide 20 to facilitate retention of the lock mode selector slide 20 in one or more of the frame lock or friction lock modes, when selected. The distal end of the lock mode selector slide 20 abuts a root end 32 of the blade proximal to the pivot 10. The fastener 44 may be tightened to retain the lock mode selector slide 20 in a selected orientation.

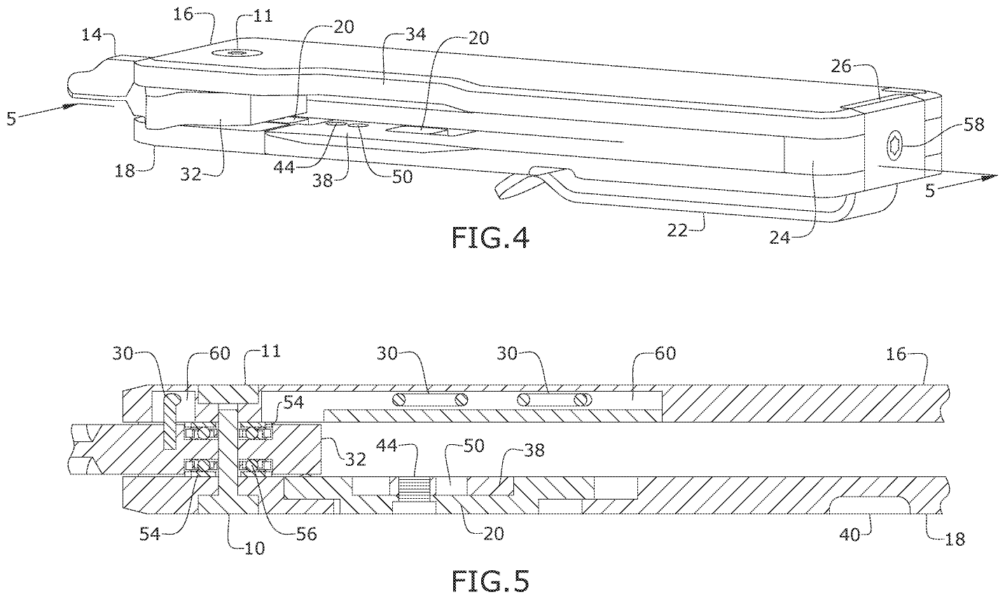

As seen in reference to FIGS. 4 and 5, illustrating the friction lock position, when the blade 14 is in the extended position from the main body frame, a cut line 40 on the main body allows the tension piece 38 of the main body frame to flex inwardly, creating a frictional tension in abutment with a side surface of the blade 14. When the lock mode selector slide 20 is positioned towards the root end 32 of the blade 14, the main body frame will apply pressure onto the blade, it creates friction between the blade 14 and main body frame, so the blade 14 can be retained in the open position without being fully locked, which is the friction lock mode in which the knife operates like a folding pocket knife. In some embodiments, the lock mode selector slide 20 may be oriented to position a detent ball 46 in abutment with a side surface of the root end 32 of the blade 14. The root 32 of the blade 14 may have a corresponding detent to facilitate retention of the blade 14 in the extended position.

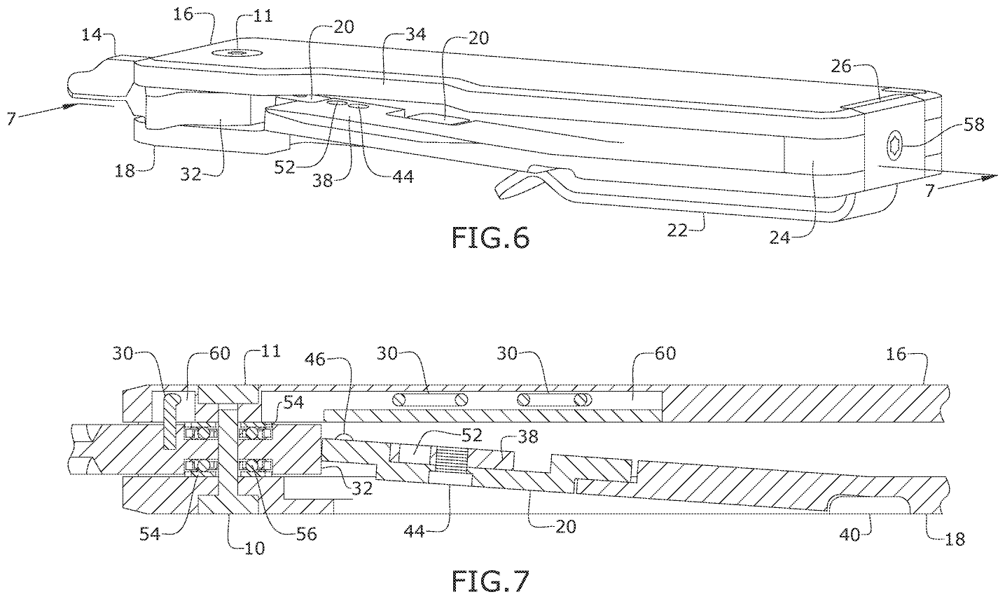

As seen in reference to FIGS. 6 and 7, illustrating the frame lock configuration, the lock mode selector slide 20 is positioned to place a distal end of the lock mode selector slide 38 in abutment with the root end 32 of the blade 14. In this position, the blade 14 is prevented from pivoting about the pivot 10, 11, placing the knife in the frame lock mode. The screw 44 may be tightened in the aperture 50 to further secure the blade 14 in the frame lock configuration.

A proximal end of the main body frame may provide for a variety of carrying options. For example, the proximal end may have an aperture 64 for securing the knife with a lanyard or a snap link. Alternatively, the proximal end may be fitted with an adapter 24 configured to carry a pocket clip 22. The pocket clip 22 may be secured with pins 48 and a fastener 58. In other embodiments, a hammer plate 26 may be provided at the proximal end of the main body to facilitate striking objects.

In some countries or areas, carrying a frame lock folding knife is illegal. When traveling to these countries, the user may simply place the knife is friction lock mode to resolve the issue. Friction folding knifes don't fully lock the blade when in use, so these can be impractical to use it on heavy duty projects. In these circumstances, frame lock knife is a better choice for heavy duty products. Giving the user the freedom to choose the knife in friction lock mode or frame lock mode, solves the complication.

It should be understood, of course, that the foregoing relates to exemplary embodiments of the invention and that modifications may be made without departing from the spirit and scope of the invention as set forth in the following claims.

What is claimed is:

1. A knife, comprising:
a main body frame having a proximal end, a distal end, and an interior cavity;
a blade having a root that is pivotally carried on a pivot at the distal end; the blade moveable between a stowed position and an extended position; and
a switch mechanism carried with the main body frame, the switch mechanism operable between a friction lock mode, in which the blade is moveable between the stowed position and the extended position, and a frame lock mode, in which the blade locked in a fixed extended position relative the main body frame.

2. The knife of claim 1, further comprising:
a tension piece resiliently moveable within the interior cavity; and
a lock mode selector slide carried on the tension piece, the lock mode selector slide operable to select between the friction lock mode and the frame lock mode.

3. The knife of claim 2, wherein in the friction lock mode, a distal end of the lock mode selector slide is in frictional contact with a side surface of the root of the blade.

4. The knife of claim 3, wherein in the frame lock mode, a distal end of the lock mode selector slide is positioned within the interior cavity and in abutment with a butt end of the root of the blade.

5. The knife of claim 4, further comprising:
a fastener configured to retain the lock mode selector slide in one or more of the friction lock mode and the frame lock mode.

6. The knife of claim 4, further comprising:
a detent ball carried by the lock mode selector slide, the detent ball configured to retain the lock mode selector slide in one or more of the friction lock mode and the frame lock mode.

7. The knife of claim 4, further comprising:
a spring element carried within the main body frame;
a tang at a distal end of the spring element configured for engagement with the root of the blade to apply a tension to the blade to retain the blade in each of the stowed position and the extended position.

8. A locking mechanism for a knife having a main body frame, a proximal end, a distal end, and an interior cavity, the main body frame adapted to pivotally carry a blade moveable between a stowed position and an extended position, the locking mechanism comprising:
a switch mechanism carried with the main body frame, the switch mechanism operable between a friction lock mode, in which the blade is moveable between the stowed position and the extended position, and a frame lock mode, in which the blade locked in the extended position relative the main body frame.

9. The locking mechanism of claim 8, further comprising:
a tension piece resiliently moveable to selectively protrude within the interior cavity; and
a lock mode selector slide carried on the tension piece, the lock mode slide operable to select between the friction lock mode and the frame lock mode.

10. The locking mechanism of claim 9, wherein in the friction lock mode, a distal end of the lock mode selector slide is positionable in frictional contact with a side surface of a root of the blade.

11. The locking mechanism of claim 9, wherein in the frame lock mode, a distal end of the lock mode selector slide is positioned within the interior cavity for abutment with a butt end of a root of the blade.
